(19) United States
(12) Patent Application Publication
(10) Pub. No.: US 2007/0237487 A1
(43) Pub. Date: Oct. 11, 2007

(54) Computer bag

(75) Inventor: Tien-Lai Lin, Taipei City (TW)

Correspondence Address: TROXELL LAW OFFICE PLLC, SUITE 1404, 5205 LEESBURG PIKE, FALLS CHURCH, VA, 22041, US

(73) Assignee: CASE PAX INT'L. CO., LTD.

(21) Appl. No.: 11/385,795

(22) Filed: Mar. 22, 2006

(51) Int. Cl. G02B 6/00

(52) U.S. Cl. 385/147

(57) ABSTRACT

A computer bag includes a layer of soft buffering piece disposed on inner/outer surface of the bag. The soft buffering piece consists of a surface layer, a middle layer and a bottom layer. The soft buffering piece includes a surface layer made from elastic textile such as Lycra, a middle layer made from waterproofing soft rubber such as styrene-butadiene rubber (SBR) and a bottom layer made from clothes such as jersey cloth. Then the three layers are hot pressing into an integrated piece with certain thickness. And a plurality of projecting units having projecting bars and projecting rings surrounding thereof are disposed evenly on surface of surface layer so as to form a buffering layer. Thus the computer bag has better buffering effect for protecting things therein.

### BACKGROUND OF THE INVENTION

The present invention relates to a computer bag, especially to a portable computer bag with buffering piece that have inner/outer buffering layers and is disposed on inner/outer surfaces of the bag so as to have better buffering effect for protecting portable computers in the bag.

Portable computers or other 3C electronics (Computer, Communication, Consumer Electronics) such as mobile phones, Personal Digital Assistant (PDA) have become essential equipment for users. Users always put the portable computers or 3C electronics inside a bag such as handbag or backpack that against shock and vibration for carrying. However, conventional computer bags use foam disposed between inner/outer layers of the bag. Limited by shape or size of the bags, the thickness of the foam is restricted. Moreover, the anti-shock and anti-vibration effect of the foam is not enough. Thus it is necessary to provide computer bags with better buffering effect for protection of notebooks or other high precision electronics.

### SUMMARY OF THE INVENTION

It is a primary object of the present invention to provide a computer bag with a soft buffering piece disposed on inner/outer surface thereof. The soft buffering piece includes a surface layer made from elastic textile, a middle layer made from waterproofing soft rubber and a bottom layer made from clothes. The middle layer is clipped between the surface layer and the bottom layer, connected with each other by hot pressing so as to form a buffering piece with certain thickness. Moreover, a plurality of projecting units is formed on outer surface of the surface layer by hot pressing. Therefore, water-proofing and buffering effects of computer are improved.

It is another object of the present invention to provide a computer bag with soft buffering piece consisting of a surface layer made from Lycra, Nylon (polyamide fiber), or polyester textile, a middle layer made from soft rubber such as styrene-butadiene rubber (SBR), polybutadiene rubber (BR), thermoplastic elastomer (TPE) or acrylonitrile-butadiene rubber (NBR) so as to form an inner buffering layer, and a bottom layer made by jersey cloth. The surface layer, the middle layer and the bottom layer is connected and integrated with each other by hot pressing. At the same time, a plurality of projecting unit are hot pressed on outer surface of the surface layer is disposed evenly so as to form an outer buffering layer. Thus the thickness of the soft buffering piece is reduced and the buffering piece is water-proofing and buffering effect. The invention is easy to be mass-produced with reduced manufacturing cost.

It is a further object of the present invention to provide a computer bag whose soft buffering piece has reduced thickness and thus is easy to be disposed on each position of inner/outer surfaces of computer bags according to users' needs so as to increase styles and functions of the computer bags. Therefore, users have multiple choices.

### BRIEF DESCRIPTION OF THE DRAWINGS

FIG. 1 is a perspective view of an embodiment in accordance with the present invention;

FIG. 2 is a schematic drawing showing a soft buffering piece in accordance with the present invention;

FIG. 3 is a partial enlarged view of FIG. 2;

FIG. 4 is a partial cross-sectional view of the soft buffering piece in accordance with the present invention;

FIG. 5 is a perspective view of another embodiment in accordance with the present invention;

FIG. 6 is a perspective view of a further embodiment in accordance with the present invention;

FIG. 7 is a perspective view of a further embodiment in accordance with the present invention.

### DETAILED DESCRIPTION OF THE PREFERRED EMBODIMENT

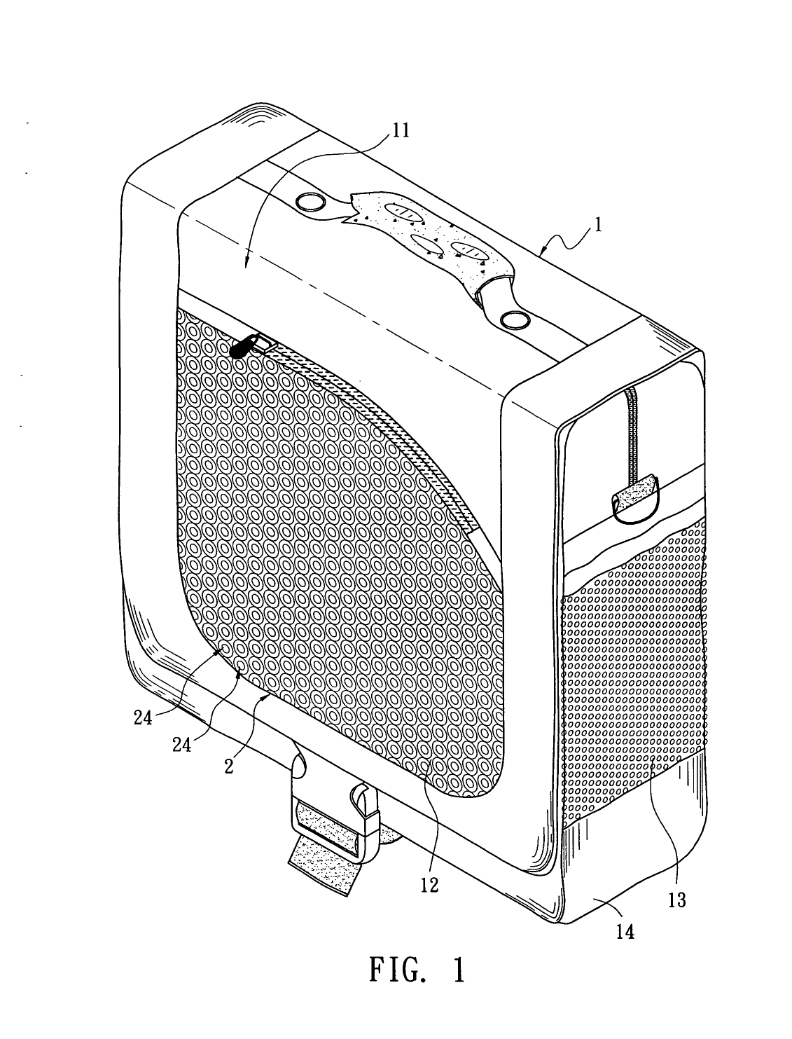

Refer to FIG. 1, a computer bag in accordance with the present invention consists of a main body 1 and a soft buffering piece 2. There is no limitation on material and shape of the main body 1. It can be various styles such as handbags or backpacks while the soft buffering piece 2 is disposed on various positions on inner or outer surface of the main body 1 without limitations. For example, as shown in FIG. 1, the soft buffering piece 2 is set on surface of a small pocket 12 on top of a cover 11 so as to buffer the shock for protecting portable computers in the main body 1, or 3C electronics such as Personal Digital Assistant (PDA) or mobile phones inside the small pocket 12.

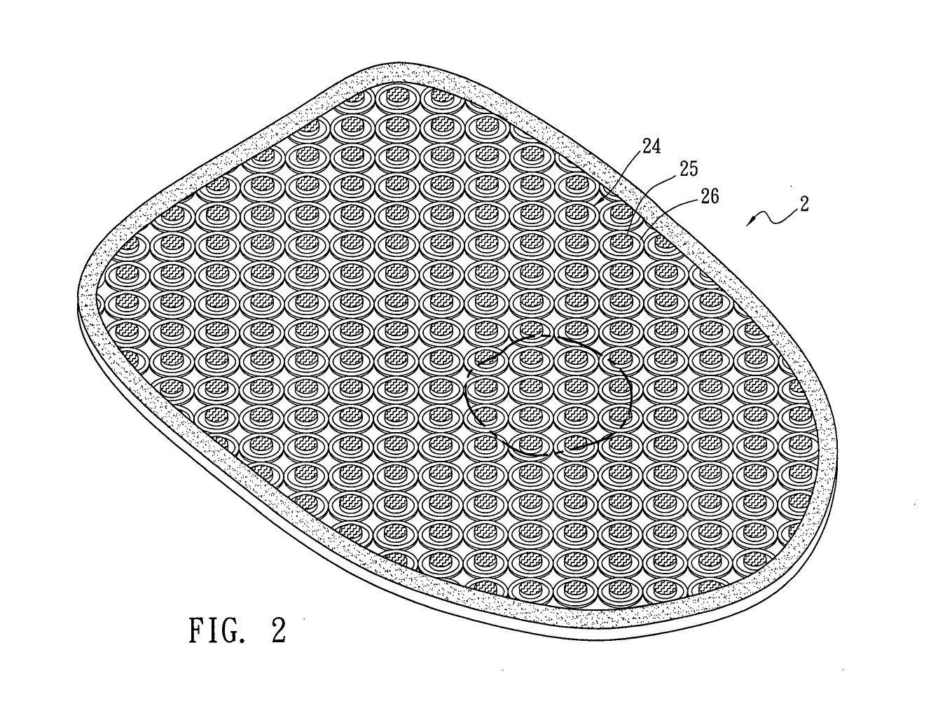

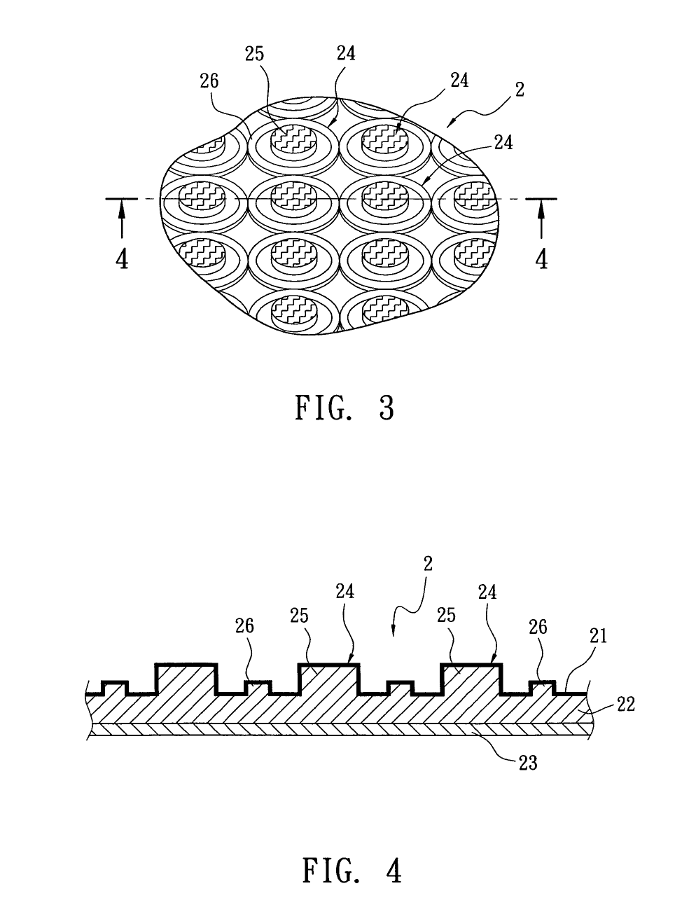

Refer from FIG. 2 to FIG. 4, the soft buffering piece 2 is composed by a surface layer 21, a middle layer 22 and a bottom layer 23. The surface layer 21 is made from elastic textile such as Lycra, Nylon (polyamide fiber), or polyester while the middle layer 22 is made from soft rubber such as styrene-butadiene rubber (SBR), polybutadiene rubber (BR), thermoplastic elastomer (TPE) or acrylonitrile-butadiene rubber (NBR). And the bottom layer 23 is made by a layer of clothes such as jersey cloth. The surface layer 21, the middle layer 22 and the bottom layer 23 are integrated into one piece with certain thickness formed by hot pressing and the middle layer 22 is clipped between the surface layer 21 and the bottom layer 23, connected with each other by heat sealing for preventing falling off. Moreover, while running hot press, by design of inner surface of top mold of hot press, a plurality of projecting units 24 is formed on surface of the surface layer 21 evenly.

Each of the projecting units 24 includes a central projecting bar 25 and a projecting ring 26 surrounding the central projecting bar 25. The diameter of the projecting bar 25 is about 7 mm while the height thereof is about 2 mm. The diameter of the projecting ring 26 is about 13 mm while the height thereof is about 1 mm. The width of ring is about 2 mm. And the projecting units 24 are disposed evenly through the whole surface of the surface layer 21 so as to form an outer buffering layer. Thus the soft buffering piece 2 has both inner buffering layer formed by the middle layer 22 and outer buffering layer formed by the projecting units 24 so as to achieve better buffering effect. Furthermore, the soft rubber of the middle layer 22 is with good water-proofing effect so that the soft buffering piece 2 is also water-proofing.

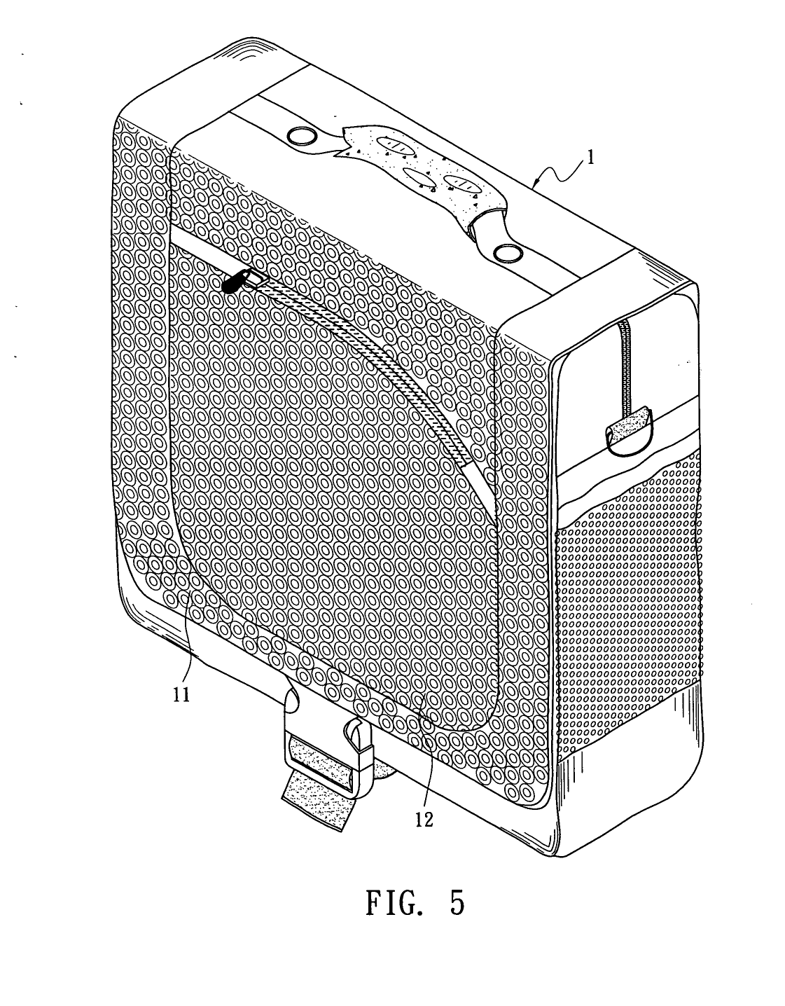

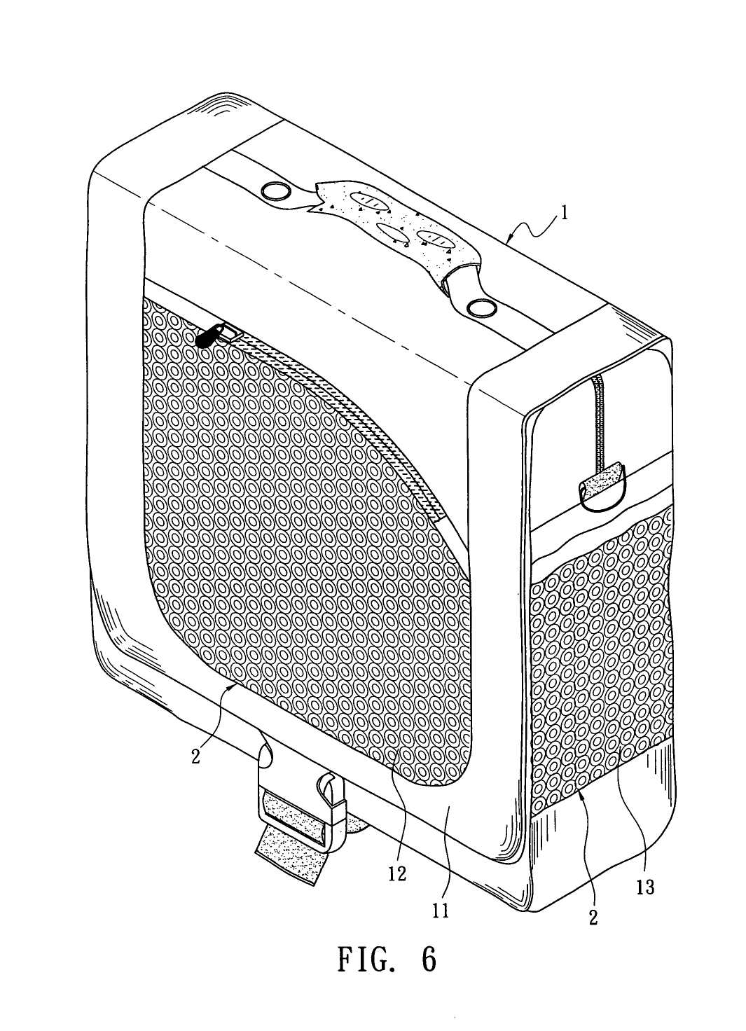

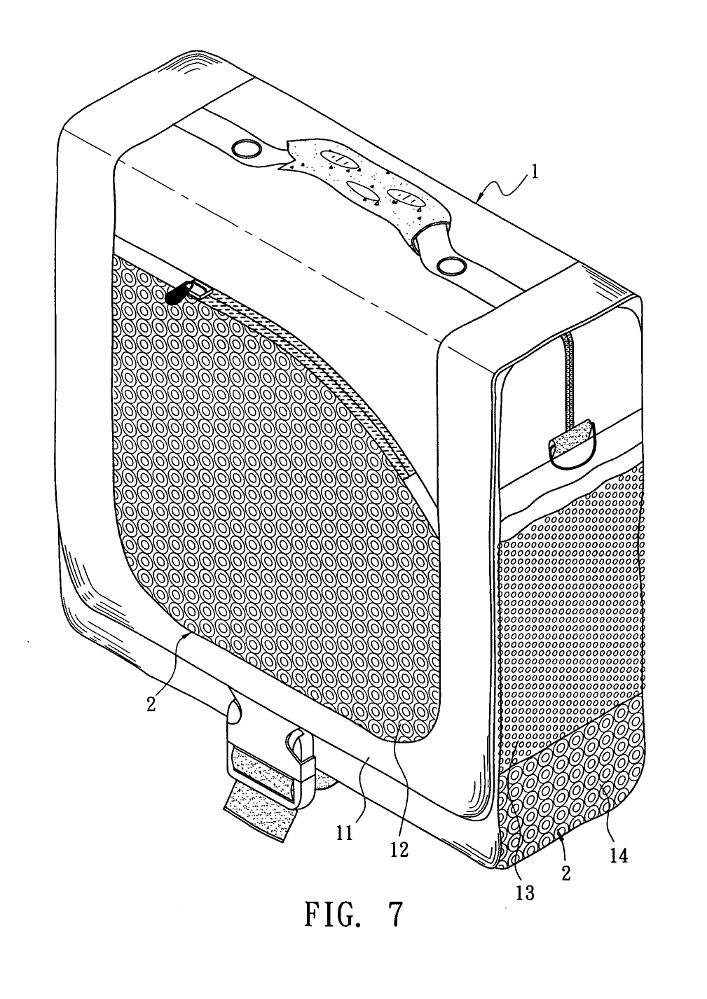

The processes of hot pressing are not difficult. And the thickness of the soft buffering piece 2 is minimized while still with good water-proofing and buffering effects. Thus the production of the soft buffering piece 2 is easy to be mass-produced with lower cost so that the soft buffering piece 2 can be disposed on each positions of inner/outer surface of the computer bags according to design requirements. For example, the soft buffering piece 2 is disposed on outer surface of a small pocket 12 of the cover surface 11, or as shown in FIG. 5, on whole outer surface of the cover 11. Refer to FIG. 6, on whole outer surface of the cover 11 and surface of a side bag 13, or as shown in FIG. 7, on bottom 14 of the main body 1. It may also arrange on inner surface of the bag (not shown in figure).

1. A computer bag comprising a main body and a soft buffering piece, wherein
the main body is a bag for accommodation of portable computers, personal assistant (PDA), mobile phones and the likes;
the soft buffering piece having a surface layer, a middle layer and a bottom layer is disposed on inner/outer surface of the main body; wherein the surface layer is made from elastic textile, the middle layer is made from waterproofing soft rubber so as to form an inner buffering layer, and bottom layer is made by a layer of clothes; the surface layer, the middle layer and the bottom layer are integrated into one piece by hot pressing; meanwhile a plurality of projecting units are formed on surface of the surface layer, disposed next to each other evenly so as to form an outer buffering layer;
thereby the soft buffering piece having the inner buffering layer formed by the middle layer as well as the outer buffering layer formed by the projecting units so as to make the main body have better buffering effect.

2. The device as claimed in claim 1, wherein the main body is a handbag or a backpack.

3. The device as claimed in claim 1, wherein the surface layer is made from Lycra, Nylon (polyamide fiber), polyester textile.

4. The device as claimed in claim 1, wherein the middle layer is soft rubber made from styrene-butadiene rubber (SBR), polybutadiene rubber (BR), thermoplastic elastomer (TPE) or acrylonitrile-butadiene rubber (NBR) so as to form an inner buffering layer.

5. The device as claimed in claim 1, wherein the bottom layer made by jersey cloth.

6. The device as claimed in claim 1, wherein the projecting units comprising a central projecting bar and a projecting ring surrounding the central projecting bar. The diameter of the projecting ring 26 is about 13 mm while the height thereof is about 1 mm.

7. The device as claimed in claim 1, wherein the diameter of the projecting bar is 7 mm while the height thereof is 2 mm.

8. The device as claimed in claim 6, wherein the diameter of the projecting bar is 7 mm while the height thereof is 2 mm.

9. The device as claimed in claim 1, wherein the diameter of the projecting ring is 13 mm, the height thereof is 1 mm and the width of the ring is 2 mm.

10. The device as claimed in claim 6, wherein the diameter of the projecting ring is 13 mm, the height thereof is 1 mm and the width of the ring is 2 mm.

11. The device as claimed in claim 1, wherein the soft buffering piece is disposed on any positions of inner/outer surface of the main body.

12. The device as claimed in claim 8, wherein soft buffering piece is disposed on surface of a cover of the main body, surface of a side bag, surface of bottom side of the main body, or inner surface of the main body.
